(19) United States
(12) Patent Application Publication
(10) Pub. No.: US 2018/0023290 A1
(43) Pub. Date: Jan. 25, 2018

(54) DUCTED PANEL ARRANGEMENT

(71) Applicant: James V. Kinser, JR., LaGrange, KY (US)

(72) Inventor: James V. Kinser, JR., LaGrange, KY (US)

(21) Appl. No.: 15/652,270

(22) Filed: Jul. 18, 2017

Related U.S. Application Data
(60) Provisional application No. 62/364,882, filed on Jul. 21, 2016.

(51) Int. Cl. E04B 1/80; F25D 13/00; F25D 23/06; H05B 3/28; E04C 2/292; E04B 1/61

(52) U.S. Cl. CPC E04B 1/806; E04C 2/292; E04B 1/6183; F25D 23/06; F25D 23/061; F25D 23/065; H05B 3/28; F25D 13/00; F25D 2201/126

(57) ABSTRACT

A modular panel arrangement for erecting a prefabricated room, the panel includes inner and outer planar skins, an insulated core, and an interior chamber isolated from said insulated core, wherein said interior chamber has an inlet opening and an outlet opening so that air can flow into said panel through said inlet opening, through said interior chamber and out of said panel through said outlet opening.

### BACKGROUND

This application claims priority from U. S. Provisional Application Ser./No. 62/364,882 filed Jul. 21, 2016.

The present invention relates to a ducted panel arrangement for insulated panels such as those used in pre-fabricated walk-in coolers.

Walk-in coolers and environmental test chambers typically are constructed of individual, modular, insulated panels which are latched together with hooks on one panel which engage pins on an adjacent panel. The hooks are mounted on a cam arrangement so they can be rotated to pull the panels tightly together. The panels typically are fabricated from an expanded polyurethane foam insulation which is blown in between walls of relatively thin metal skins (typically 22 gauge steel or stainless steel). The panel ends are designed to match up in a tongue and groove configuration with the ends of the metal skins abutting each other. A similar panel is described in U.S. Pat. No. 8,528,288“Kinser”, Insulated Panel Arrangement, issued Sep. 10, 2013, which is hereby incorporated herein by reference.

While these chambers, made of modular wall panels, can be installed in the field just by latching them together, they still require in-the-field modification, involving the use of on-site pipe fitters and sheet metal fabricators, in order to accommodate utility piping and ductwork to heat and cool the room. This is expensive and time-consuming.

### SUMMARY

An embodiment of the present invention provides a modular panel including an internal chamber that functions as a duct chase, such that the required ductwork is already present as the prefabricated room is assembled from the modular panels. External duct work or supply air piping is connected directly to one or more of the duct-chase panels to take the air-conditioned air from outside of the room to inside of the room without having to field-modify any of the panels. These same duct-chase panels may be used to provide a return air duct from the inside of the room to the outside of the room. Of course, these internal chambers also may be used to run other utilities, such as water piping or electrical wiring, into or out of the prefabricated room.

The duct chase panel preferably has the same outside dimensions as the other modular, insulated panels and uses the same hook-and-rod latching arrangement of the other modular, insulated panels such that the duct chase and the other modular panels are interchangeable in the assembly of the prefabricated room.

### BRIEF DESCRIPTION OF THE DRAWINGS

FIG. 1 is a side view of two prior art insulated panels, with the panels partially broken away to show two of the latch mechanisms;

FIG. 2 is a view along line 2-2 of FIG. 1;

FIG. 3 is a view along line 3-3 of FIG. 1;

FIG. 4 is a view of detail 4 of FIG. 1;

FIG. 5 is a view taken along line 5-5 of FIG. 1, showing that the prior art panel is filled with insulation.

FIG. 6 is a view similar to that of FIG. 5 but showing a panel with a built-in chase;

FIG. 7 is a view similar to FIG. 6, but for a panel using two hook assemblies instead of the single hook assembly of FIG. 6;

FIG. 8 is a view similar to FIG. 7 but showing the use of longitudinally-extending channels for structural support of the panel when using mineral wool insulation;

FIG. 9 is similar to FIG. 8 except it shows that one side of the panel may still be insulated;

FIG. 10 is similar to FIG. 7 but showing an arcuate-shaped duct instead of the rectangular duct of FIG. 7;

FIG. 11 is similar to FIG. 6 but showing electrical resistance heaters in the duct chamber;

FIG. 12 is similar to FIG. 9 but showing water piping for a misting system in the duct chamber to add humidity to the room;

FIG. 13 is similar to FIG. 11 but showing an evaporator coil for chilling the air passing through the duct chamber;

FIG. 14 is a front view of a full-length duct-chase panel made in accordance with one embodiment of the present invention, as seen from the vantage point of outside the room, showing a round connection for the conditioned air coming into the duct-chase panel and showing, in phantom, the duct chamber and a rectangular outlet for the conditioned air exiting the duct chamber and into the room;

FIG. 15 is a view similar to FIG. 14, but for a half-length duct-chase panel;

FIG. 16 shows two duct-chase panels that open at one end of their respective modular panels with the panels connected end-to-end to make a continuous chase, as may be used in the ceiling of a prefabricated room;

FIG. 17 is an enlarged, broken-away section view of the two connected duct chase panels of FIG. 16;

FIG. 18 is a plan view of the top end of the lower panel of FIG. 17, showing a flange used for sealing together the ducts of the two panels using a flat gasket;

FIG. 19 is an enlarged, plan view of the internal wall with its top edge folded over to form the flange of FIG. 18, including a detail of the internal wall where it connects to the inner skin of the modular panel; and

FIG. 20 is a section view along line 20-20 of FIG. 18, with the insulation omitted for clarity.

### DESCRIPTION

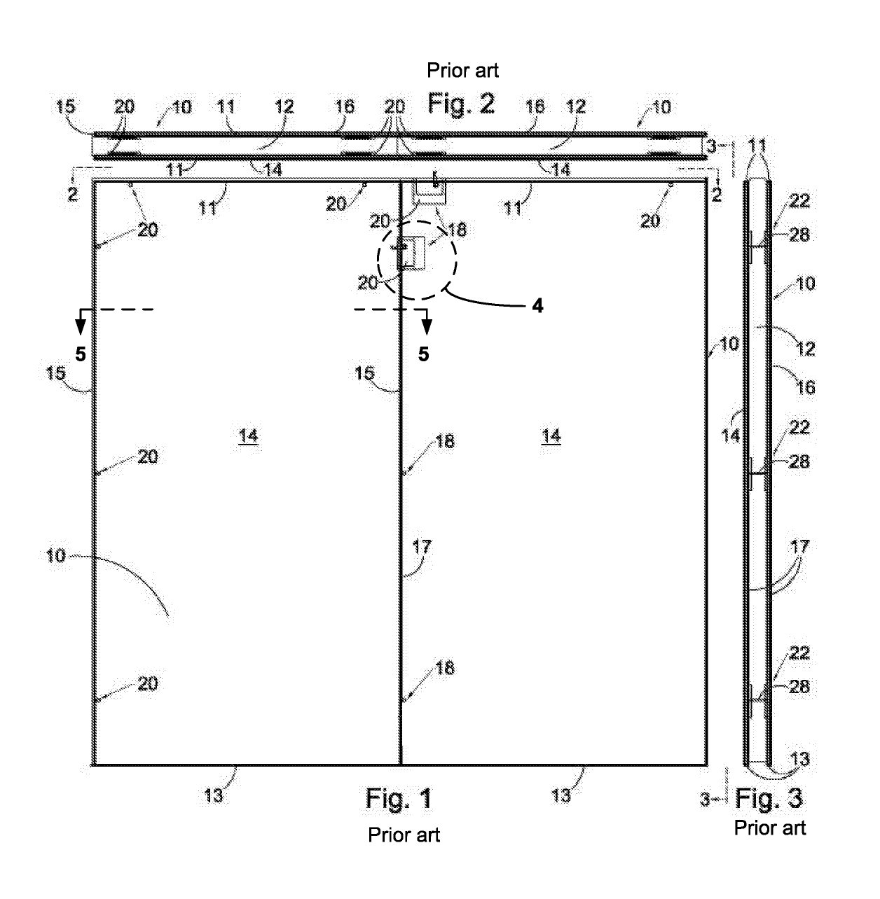

FIGS. 1 and 2 show two prior art, rectangular, insulated panels 10 fitted snugly together to form a wall. Each panel 10 is made up of an inner planar skin 14 and a parallel outer planar skin 16. An expanded polyurethane foam insulation core 12 fills the interior space between the inner and outer skins 14, 16. In this particular embodiment, the core 12 is five inches thick and the inner and outer skins 14, 16 are 22 gauge steel sheets.

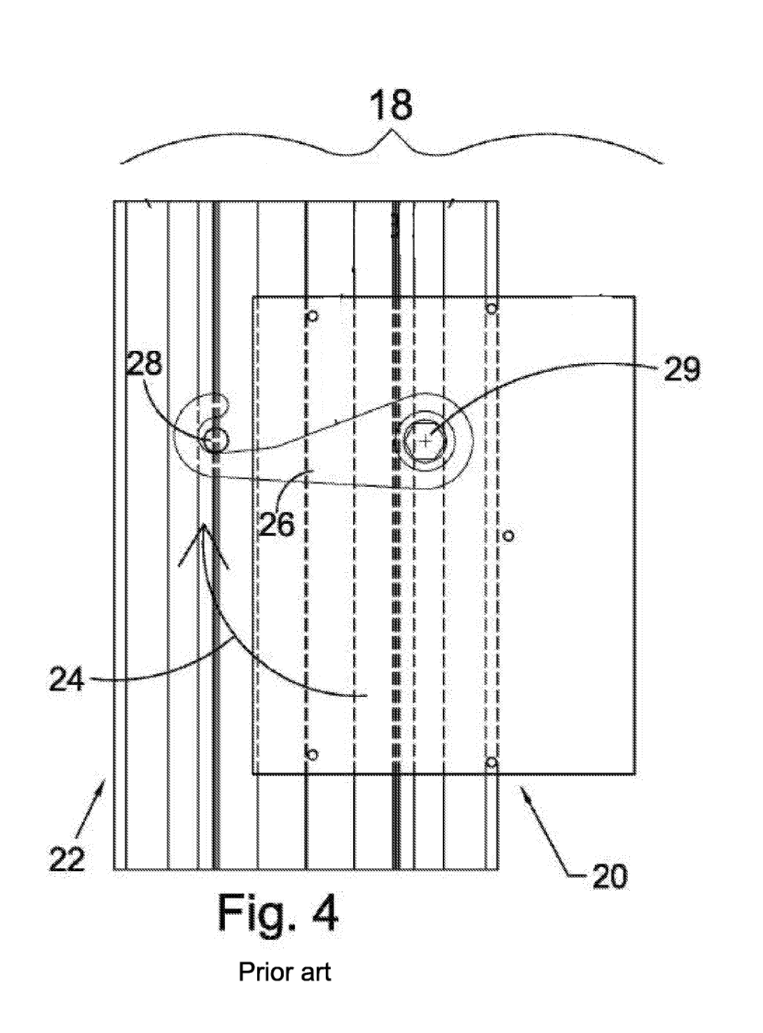

Each of the planar skins 14, 16 has a top edge 11 at the top end of the panel 10 and an opposed bottom edge 13 at the bottom end of the panel 10. Each of the planar skins 14, 16 also has a left edge 15 at the left end of the panel 10 and an opposed right edge 17 at the right end of the panel. The edges of the planar skins 14, 16 are bent toward the opposite planar skin 16, 14 to form the ends of the panel 10. Latching arrangements 18 pull the panels together. As shown in FIG. 4, a hook assembly 20, mounted on one panel 10, mates with a pin assembly 22 mounted on a second, adjacent panel 10 such that, as the hook assembly 20 is rotated in the direction of the arrow 24, the hook 26 on the hook assembly 20 engages the pin 28 on the pin assembly 22. Further rotation of a hex head wrench (not shown) on the rod 29 of the hook assembly 20 rotates the hook 26 and results in a cam action wherein the hook 26 retracts into its panel 10, pulling the pin 28 of the pin assembly 22 toward the hook assembly 20 to draw the insulated panels 10 together for a snug fit. The hook 26 is mounted on the rod 29 and rotates with the rod 29 and about the axis of the rod 29. The cam-action hook assembly 20 for this embodiment is part number 1168, supplied by Kason Industries of Woodmere, N.Y.

As shown in FIGS. 1-3, in this particular embodiment, the hook assemblies 20 are mounted on the left end and top end of each panel 10. The corresponding pin assemblies 22 are mounted on the right end and bottom end of each panel directly opposite their respective hook assemblies 20. For example, the hook assemblies 20 on the left end are at the same elevations as the respective pin assemblies 22 on the right end, which puts each hook assembly 20 directly opposite a pin assembly 22 so that, when the left end of one panel abuts the right end of another panel, the hook assemblies 20 on the left end of the one panel are properly aligned with the respective pin assemblies 22 of the other panel. Similarly, the hook assemblies 20 on the top end are directly opposite the pin assemblies 22 on the bottom end so that, when one panel 10 is placed below another with their left and right ends aligned, the hook assemblies 20 on the top end of the bottom panel are properly aligned with the pin assemblies 22 on the bottom end of the upper panel.

In this particular embodiment, each panel 10 has three hook assemblies 20 on its left end, three pin assemblies 22 on its right end, two hook assemblies 20 on its top end, and two pin assemblies 22 on its bottom end. This arrangement allows the hooks 26 on the left end of one panel 10 to engage the corresponding pins 28 on the right end of the next adjacent panel 10 to the left. It also allows the hooks 26 on the top end of one panel 10 to engage the corresponding pins 28 on the bottom end of the next adjacent panel 10 above (not shown). The insulated panels 10 have a tongue and groove configuration along the panel ends so they can match up to each other, with the tongue end of one panel being received in the groove end of the adjacent panel.

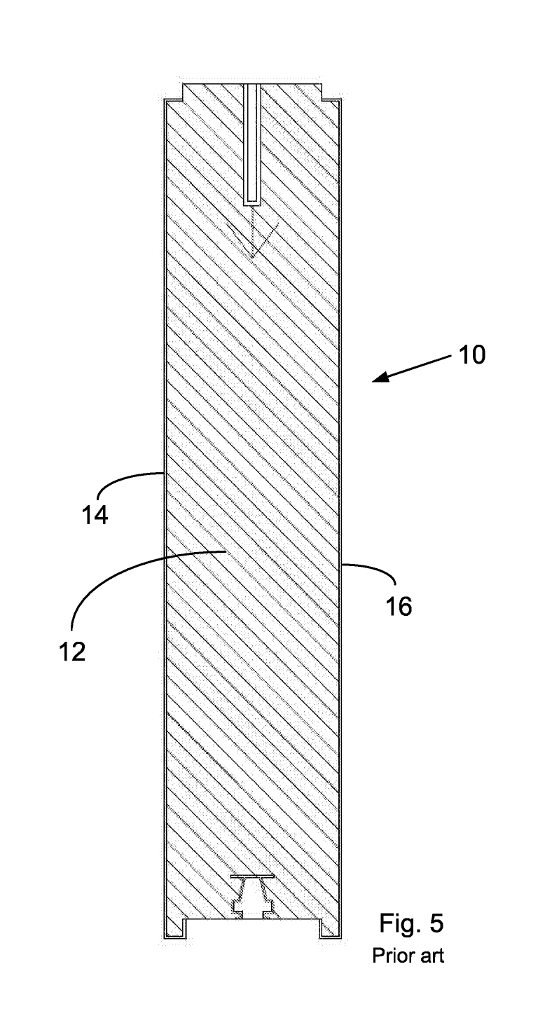

FIG. 5 is a section view along line 5-5 of FIG. 1, showing that the panel 10 is totally filled in with insulation 12 between the two skins 14, 16. As indicated earlier, the insulation may be expanded polyurethane foam insulation. It alternatively may be other insulation, such as mineral wool.

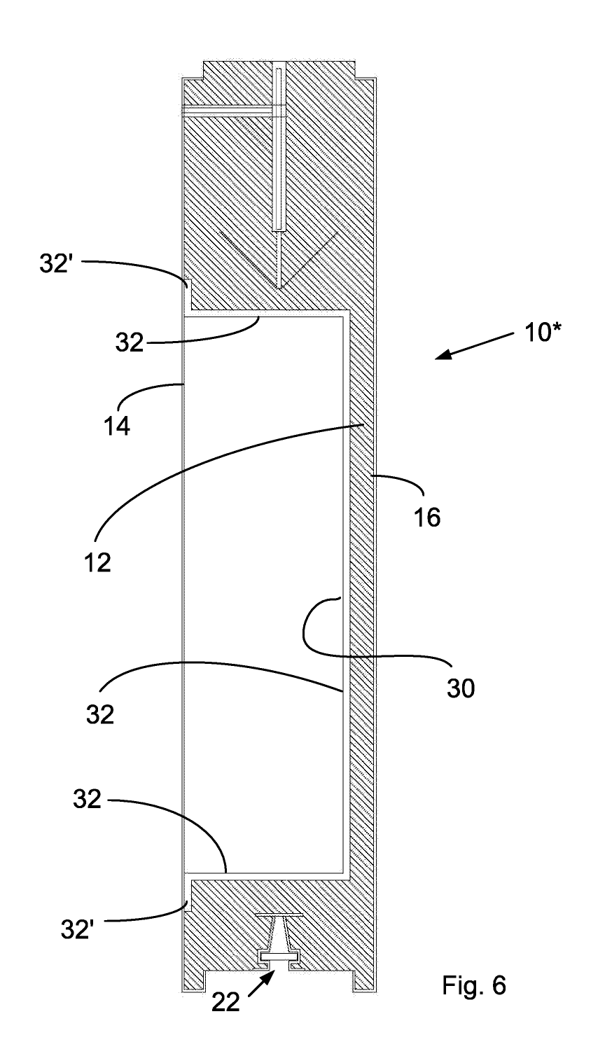

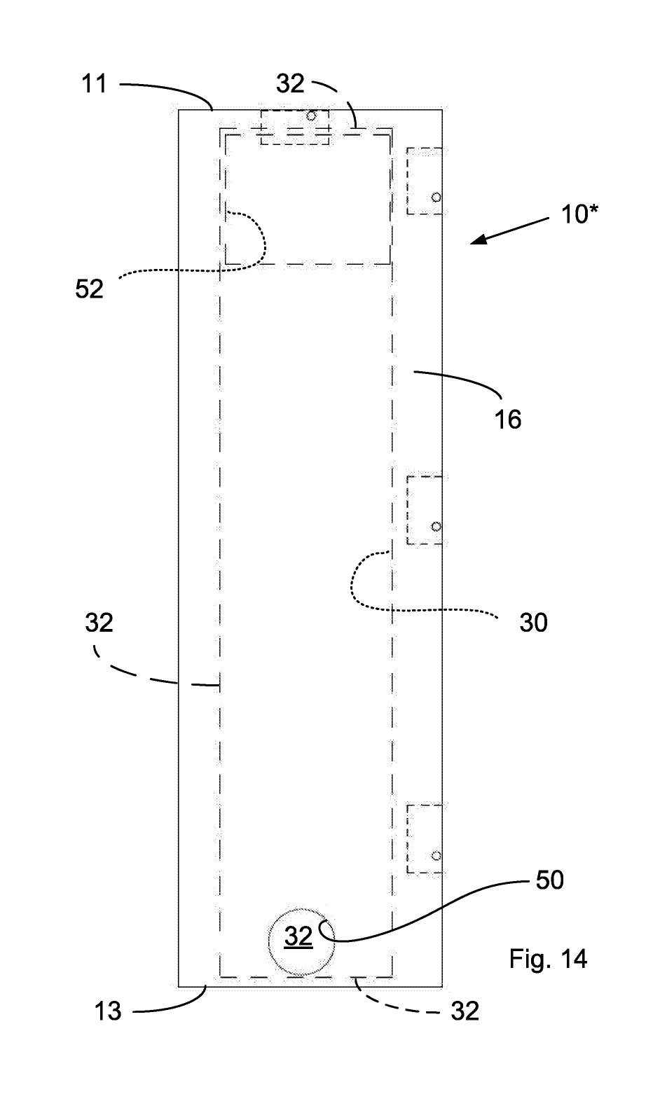

Referring now to FIG. 6, the modular duct-chase panel 10* is similar to the regular modular panel 10 of FIG. 5. However, this modular duct-chase panel 10* defines an internal chamber 30 which, in this embodiment, extends longitudinally from close to its bottom edge 13 (See FIG. 14) to close to its top edge 11. A thin, internal wall 32 lies between the inner and outer planar skins 14, 16 and abuts the inner planar skin 14 to define an internal chamber 30 having an inlet 50 (See FIG. 14) and an outlet 52, as explained in more detail later.

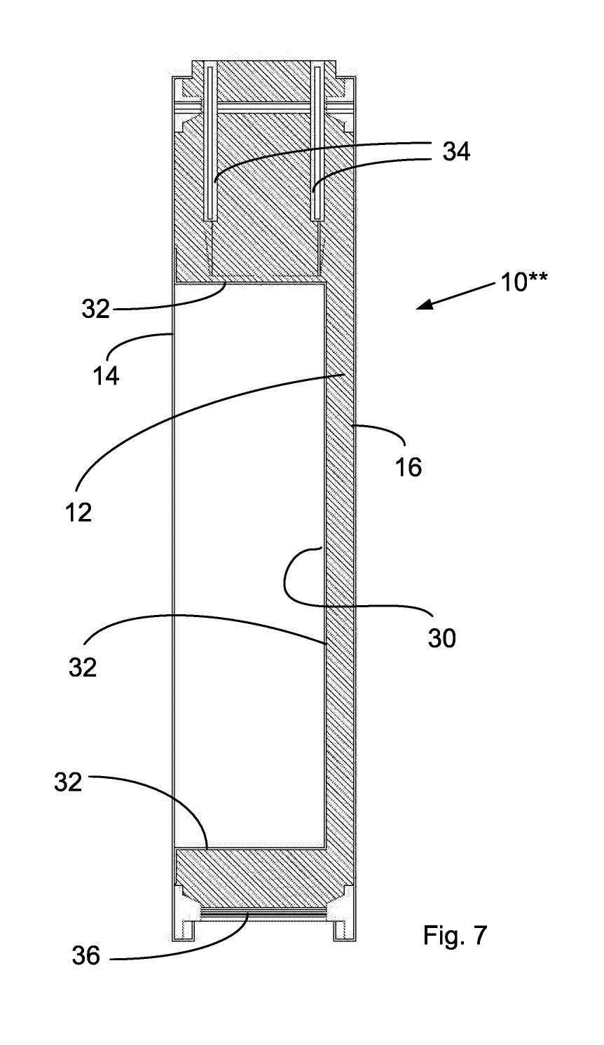

The thin internal wall 32 has the same U-shaped profile along its full length and includes a top closure wall portion and a bottom closure wall portion to complete the enclosure forming the internal chamber 30. The internal wall 32 has ears 32′ that project away from the chamber 30, parallel to and adjacent to the inner skin 14. These ears 32′ are secured to the inner surface of the inner skin 14, as by gluing or tack welding, for instance. As best appreciated in FIGS. 7 and 14, the internal wall 32 and the inner skin 14 together enclose and form the internal chamber 30 and isolate the internal chamber 30 from the insulation 12.

The internal enclosure wall 32 prevents encroachment of the expanded foam insulation 12 into the internal chamber 30 as the insulation 12 is blown into the modular duct-chase panel 10*. The insulation 12 fills the space between the outer skin 16 and the inner skin 14 outside of the chamber 30 and surrounds the sides of the chamber 30 to maximize the insulating properties of the panel 10*.

The physical barrier formed by the combination of the internal enclosure wall 32 and the inner skin 14 isolates the internal chamber 30 from the expanded foam insulation 12 so that fluid (such as conditioned air) flowing through the internal chamber 30 is separated from the expanded foam insulation 12. It is possible that, over time and after many temperature fluctuation cycles in the room, the insulation 12 may begin to deteriorate. If that were to occur, the isolation of the internal chamber 30 from the insulation 12 would substantially prevent the fluid flowing through the chamber 30 from picking up particles of the insulation 12 and transmitting them into the room formed by the modular panels. The inlet 50 permits air to flow into the panel 10*, into the internal chamber 30, and the outlet 52 permits air to flow out of the panel 10* from inside the internal chamber 30. In one embodiment, the inlet 50 includes an opening through the outer skin 16, and the outlet 52 includes an opening through the inner skin 14.

It should be noted that the internal chamber 30 is insulated from the outer skin 16 by the insulation 12. In most instances, there is no need to insulate the chamber 30 from the inner skin 14, since any heat transfer from the chamber 30 to the inside of the room is considered advantageous and desirable.

The modular duct-chase panel 10* uses the same hook 26 and pin 28 latching arrangement present in the prior art modular insulated panel 10. In a preferred embodiment, the non-ducted modular panels 10 and the ducted modular panels 10* share the same dimensions such that they may be used interchangeably in an installation. In this manner, an existing room may be retrofitted in the field by removing a prior-art modular insulated panel 10 and installing a duct-chase modular panel 10* in its place. It should be noted that, while the modular panels 10, 10* here are depicted in a vertical orientation, to form the walls of a room, they may be oriented in other directions, such as horizontally, to form a ceiling or floor of a room.

FIG. 7 is a view similar to that of FIG. 6, which shows that the modular duct-chase panel 10** may have a two-hook assembly 34 on one end engaging a single pin assembly 36 on an opposite end of an adjacent modular panel 10**. This type of latching arrangement is fully described in U.S. Pat. No. 8,528,266“Kinser”, referenced earlier. This illustrates that a modular duct-chase panel 10*, 10** may be manufactured to conform to any latching arrangement found in prior art panels so as to enhance the ability to retrofit any existing installations.

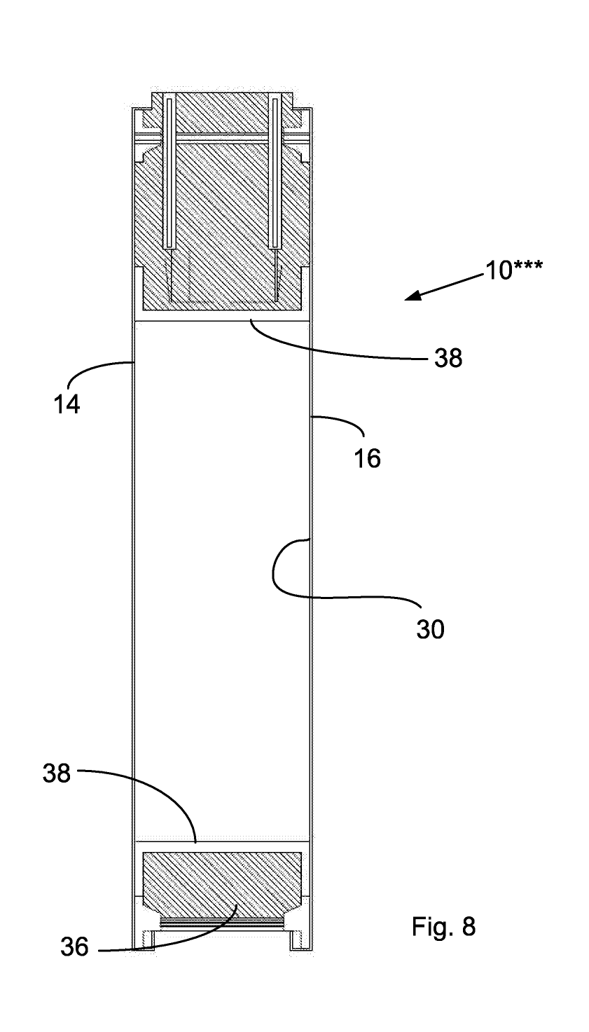

FIG. 8 is a view similar to FIG. 7, but for a high temperature modular duct-chase panel 10*** which uses mineral wool insulation instead of blown-in expanded polyurethane foam insulation. Brackets 38, each having a substantially “U”-shaped cross-sectional profile, are installed to provide structural support to the panel 10*** because, unlike the expanded polyurethane foam insulation, the mineral wool insulation provides no additional structural support. The brackets 38 extend longitudinally substantially the full length of the modular panel 10*** from close to its bottom edge 13 (See FIG. 14) to close to its top edge 11. These brackets 38 are attached, as by gluing or welding for instance, to the inner and outer skins 14, 16 of the modular panel 10***. These brackets 38 and the inside surfaces of the inner and outer skins 14, 16 form the walls of the enclosure defining the internal duct chamber 30 of the panel 10***. As in FIG. 14, top and bottom walls also are provided to close off the top and bottom ends of the internal duct chamber 30.

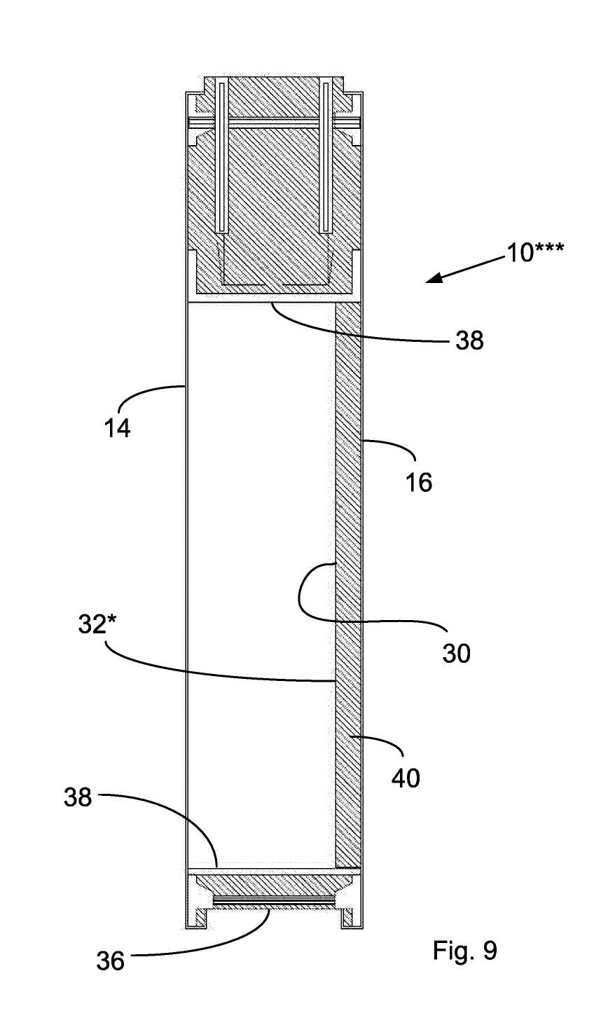

FIG. 9 shows an alternative arrangement similar to FIG. 8, but an additional wall 32* has been added to define the outer surface of the internal duct chamber 30, and a section of insulation 40 has been added in between the outer skin 16 of the modular panel 10*** and the internal wall 32* of the internal duct chamber 30 to insulate the internal duct chamber 30 from the outside of the room.

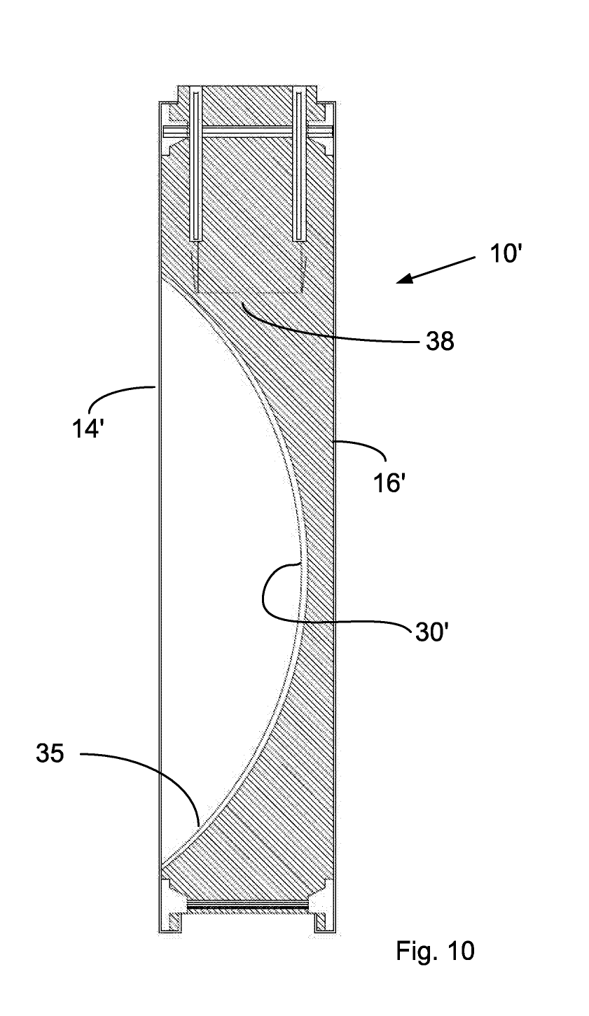

FIG. 10 shows an alternative modular duct-chase panel 10′. It may be appreciated that the internal duct chamber 30′ is defined by the inner planar skin 14′ and the arcuate-profile internal enclosure wall 35. The internal enclosure wall 35 has the same arcuate shaped profile along its full length, which has the advantage of reducing the number of corners where dirt may accumulate. As with the embodiment of FIG. 6, the internal enclosure wall 35 is secured to the inner planar skin 14′ to form the internal chamber 30. The internal enclosure wall 35 also has top and bottom portions to close off the top and bottom ends of the internal chamber 30. It will be obvious that any desired profile shape may be used for alternative embodiments of the enclosure wall.

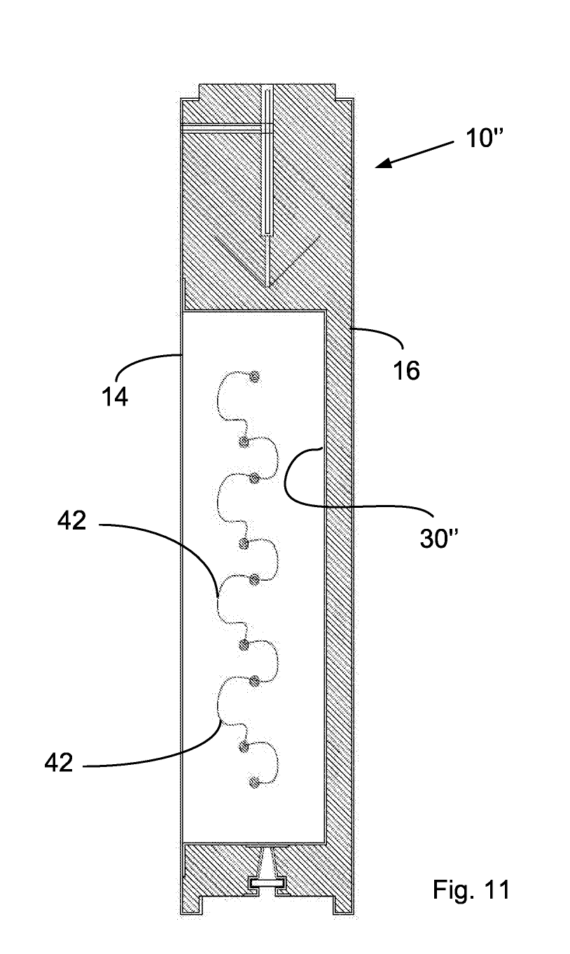

FIG. 11 shows another alternative embodiment of a modular duct-chase panel 10″. This modular duct chase panel 10″ is substantially identical to the modular duct-chase panel 10* of FIG. 6 except that it incorporates a plurality of electrical resistance heaters 42 in the internal duct chamber 30″. These heaters 42 may be electrically powered to warm up the incoming air flowing into the room. A thermostat (not shown) may be used to selectively energize the heaters 42 so as to control the temperature of the ambient air in the room.

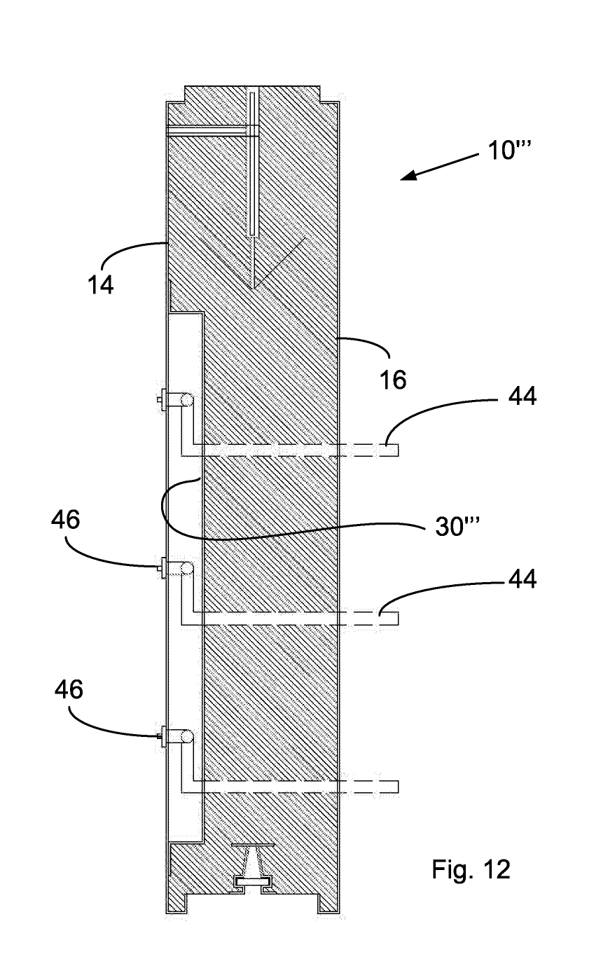

FIG. 12 shows another alternative embodiment of a modular duct-chase panel 10′″. This modular duct-chase panel 10′″ is substantially identical to the modular duct-chase panel 10* of FIG. 6 except that the internal duct chamber 30′″ occupies less of the thickness of the panel and incorporates a plurality of pipe runs 44 in the inernal duct chamber 30′″ to provide for water to be sprayed inside the room to humidify the room or to provide fire protection. These pipe runs 44 terminate in spray nozzles 46. A humidistat or other controller (not shown) is used to selectively actuate valves (not shown) which allow water to enter the pipe runs 44 and flow through the spray nozzles 46.

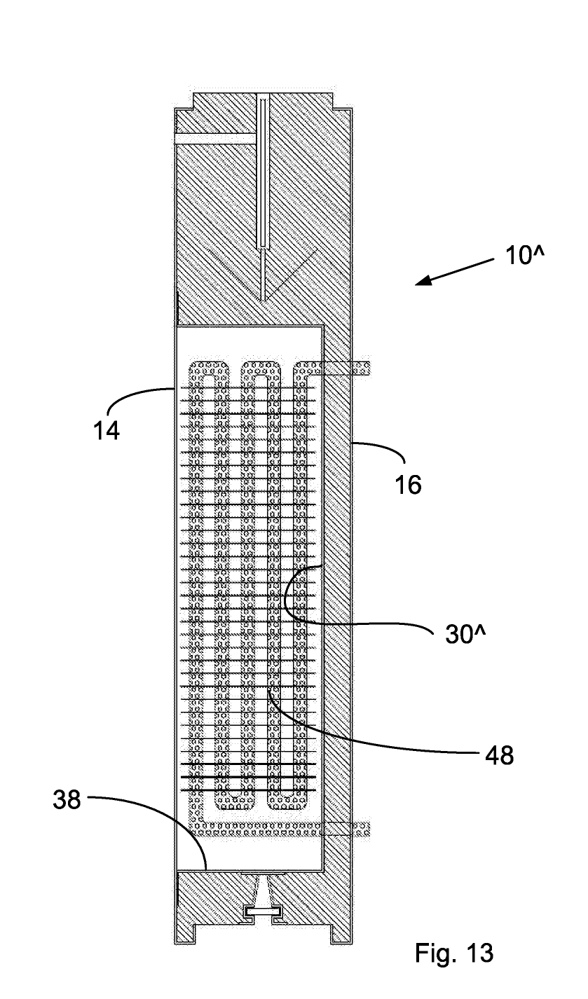

FIG. 13 shows another embodiment of a modular duct-chase panel 10̂. This modular duct-chase panel 10̂ is substantially identical to the modular duct-chase panel 10* of FIG. 6 except that it incorporates an evaporator coil 48 for chilling the air passing through the internal duct chamber 30̂. A thermostat (not shown) may be used to regulate the air conditioning system to the evaporator coil 48 so as to control the temperature of the ambient air in the room.

FIG. 14 is a front view (as seen from the right hand side) of the modular duct-chase panel 10* of FIG. 6. It represents a similar view for most of the duct-chase panels described herein. It may be observed that the internal duct chamber 30 extends substantially the full length of the modular panel 10*, with an inlet 50 close to the bottom edge 13 and an outlet 52 close to the top edge 11. The inlet 50 in this embodiment is shown as a circular opening which can be connected to the outlet hose of an air treatment system, to provide fluid communication from outside the room to the duct chamber 30 adjacent the bottom edge 13 of the duct-chase panel 10*. A rectangular opening 52 on the inner skin 14 and an enclosed path from the internal duct-chamber 30 to the rectangular opening 52 provide fluid communication from the internal duct chamber 30 to the inside of the room adjacent the top edge 11 of the duct-chase panel 10*. Conditioned air (such as heated air, cooled air, chilled air, humidified air, or dry air, as desired) may be piped from a utility (not shown), such as from an air conditioner, to the inlet opening 50. The air enters the internal duct chamber 30 via the lower, inlet opening 50 and then travels upwardly in the internal duct chamber 30 in the modular duct-chase panel 10* and through the enclosed path until it exits into the room via the upper, outlet opening 52. It should be obvious that the air flow may be reversed (such that the modular duct-chase panel 10* may act as an air return duct, for instance, pulling air in through the upper opening 52 through the inner skin and sending air out through the lower opening 50 in the outer skin 16). As shown in FIG. 14, the internal enclosure wall 32 includes top and bottom wall portions to close off the top and bottom of the internal chamber 30.

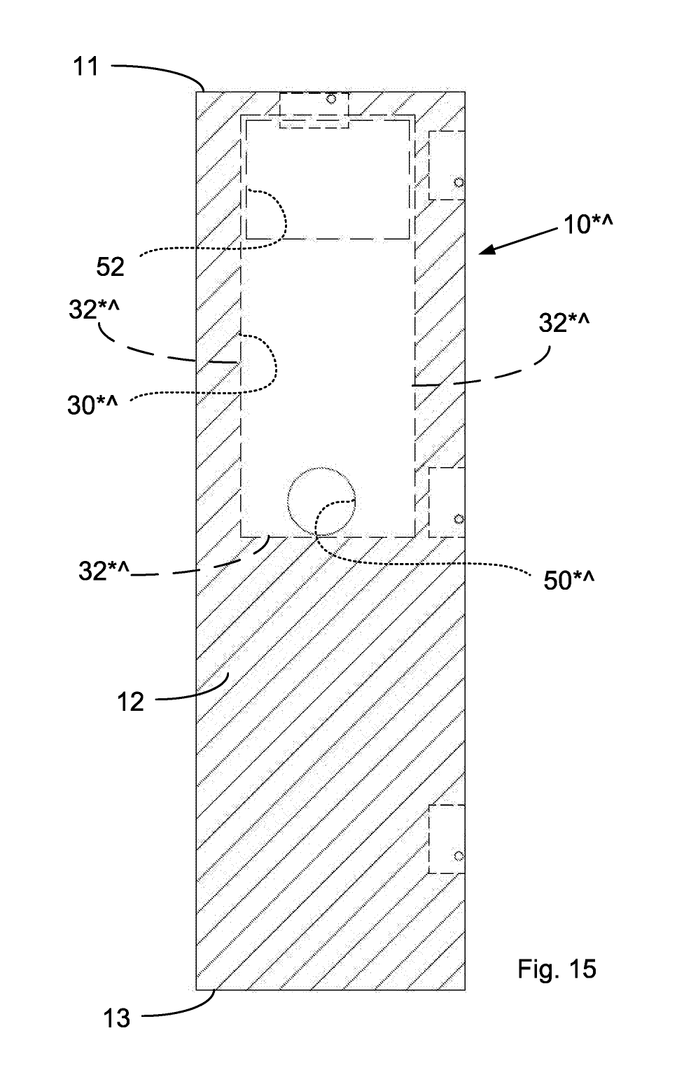

The openings 50, 52 may be located anywhere considered advantageous. For instance, in FIG. 15, the inlet opening 50*̂ through the outer skin 16 and into the internal duct chamber 30*̂ has been placed halfway up the height of the modular duct-chase panel 10*̂. The lower portion of the panel 10*̂ below the inlet 50*̂ is filled with foam insulation 12. Again, there is a wall 32*̂ of metal, plastic, or other material defining the internal duct chamber 30*̂ and isolating the internal duct chamber 30*̂ from the insulation 12. Of course, an internal duct-chase panel may have more than one inlet opening and more than one outlet opening, if desired.

In many instances, the prefabricated rooms erected using thermally-insulated, modular panels also make use of these panels for the ceiling. An example of this is shown in FIG. 14 of U.S. Pat. No. 8,528,266“Kinser, referenced earlier, which is hereby incorporated herein by reference.

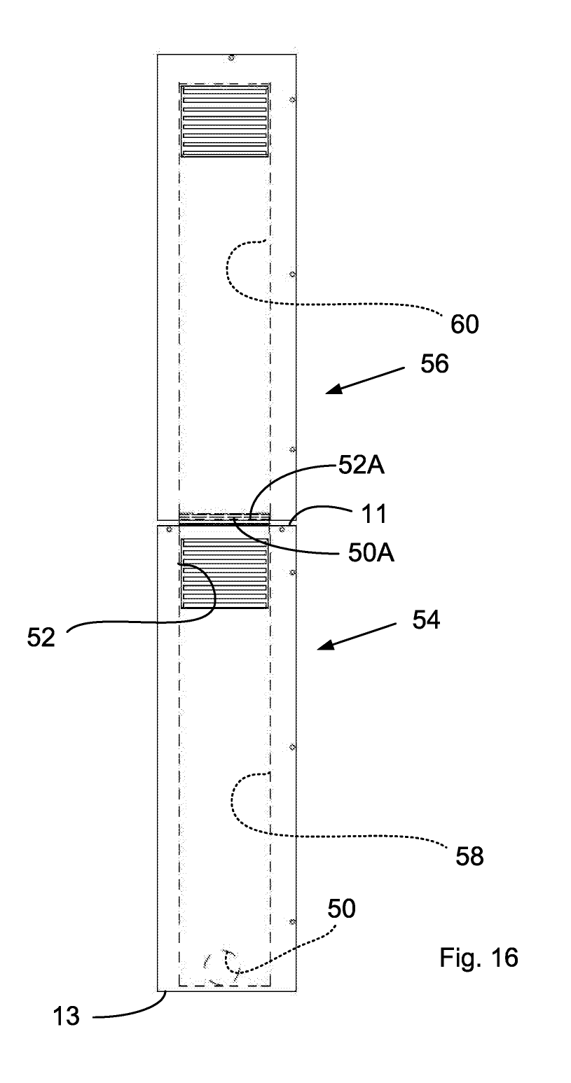

FIG. 16 shows duct-chase panels 54, 56 which have internal duct chambers 58, 60 that connect end-to-end. These may be used advantageously as ceiling panels to provide conditioned air to the room, or they may be stacked vertically to form a tall room. In this case, the modular duct-chase panel 54 is similar to the modular duct chase panel 10* of FIG. 14, having a single air inlet opening 50 and an air outlet opening 52. However, instead of being closed off at the top end to force all the air to exit through the outlet opening 52, this modular duct-chase panel 54 has a second outlet opening 52A at its top end that provides fluid communication between the internal duct chamber 58 of the lower modular duct-chase panel 54 and the internal duct chamber 60 of the adjacent upper modular duct-chase panel 56. The internal duct chamber 60 of the adjacent upper modular duct-chase panel 56 has a corresponding opening 50A at its bottom end that serves as an inlet which mates with the open top end 52A of the internal chamber 58 of the lower modular panel 54. The adjacent open ends 50A, 52A of the internal chambers 58, 60 of the adjacent panels 54, 56 provide an air outlet 52A for the lower chamber 58 and an air inlet 50A for the upper chamber 60 so conditioned air can flow through the inlet 50 of the lower chamber 58, through the lower chamber 58, out the open top end (outlet) 52A of the lower chamber 58, into the open bottom end (inlet) 50A of the upper chamber 60, through the upper chamber 60, and out the outlet 52 of the upper chamber 60. Additional modular pass-through panels (not shown) may be provided with an internal chamber that runs the full length of the panel and is open at both ends, and these modular pass-through panels may be daisy-chained together in between the panels 58, 60 as needed to allow air to flow end-to-end through a plurality of modular panels to the provide air outlets into the room where desired.

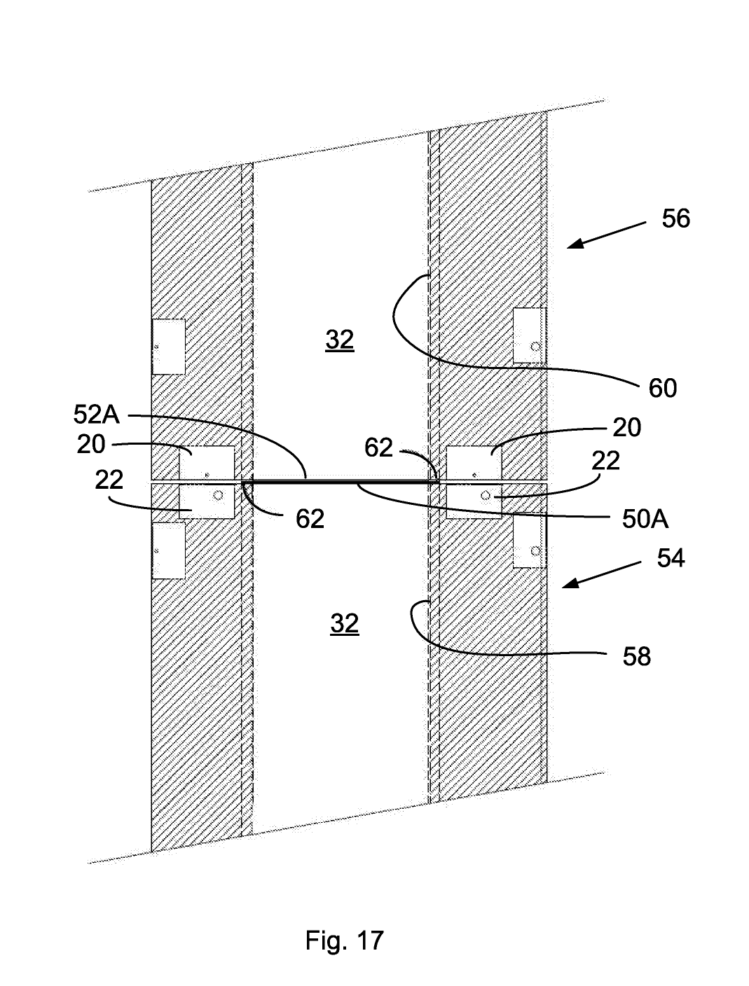

FIGS. 17-20 show more details of the joint between the two modular panels 54, 56 and between the two ducts 58, 60. There is a flange 64 at each of the open ends 52A, 50A of the internal ducts 58, 60, and these flanges 64 abut each other to help form a seal between the ducts 58, 60 at the ends 52A, 50A. In this embodiment, a gasket 62 has been placed between the abutting flanges 64 to help ensure a good seal between the ends 52A, 50A, but the force provided by the hook and pin assemblies 20, 22 (shown in FIG. 17) pressing the panels 54, 56 together may be sufficient even without a gasket 62.

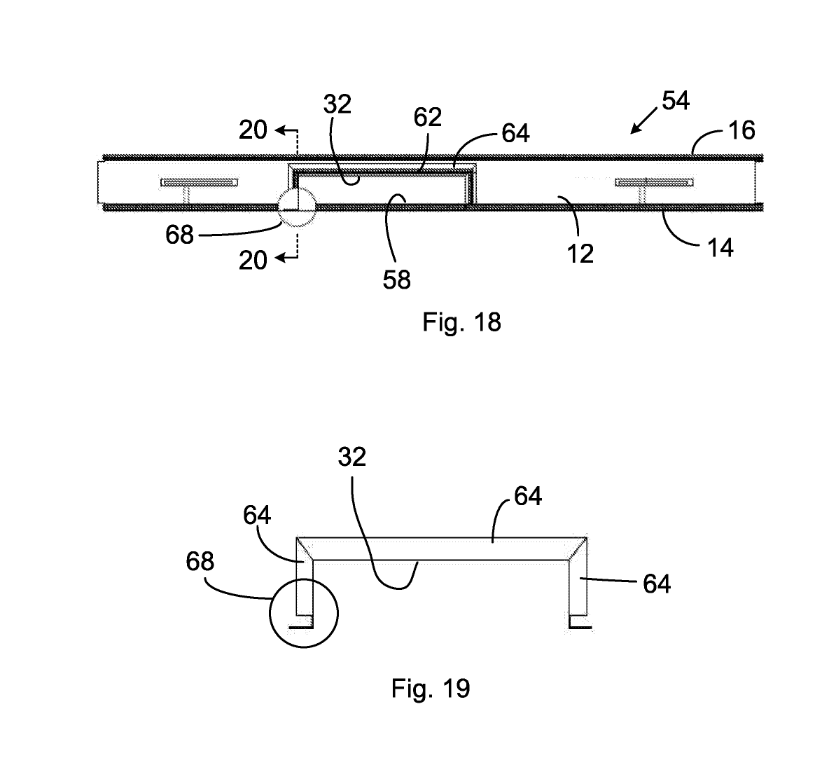

The flanges 64 at the open ends 50A, 52A are formed by bending the end of the internal wall 32 at right angles to the rest of the internal wall 32. FIGS. 18 and 19 are an end view of the internal wall 32, showing the flange 64. In this embodiment, the internal wall 32 has a cross-sectional shape that makes up three sides of a rectangle, and the inner skin 14 makes up the fourth side to complete the rectangular shape of the internal duct 58. Of course, the same is true of the adjacent duct 60.

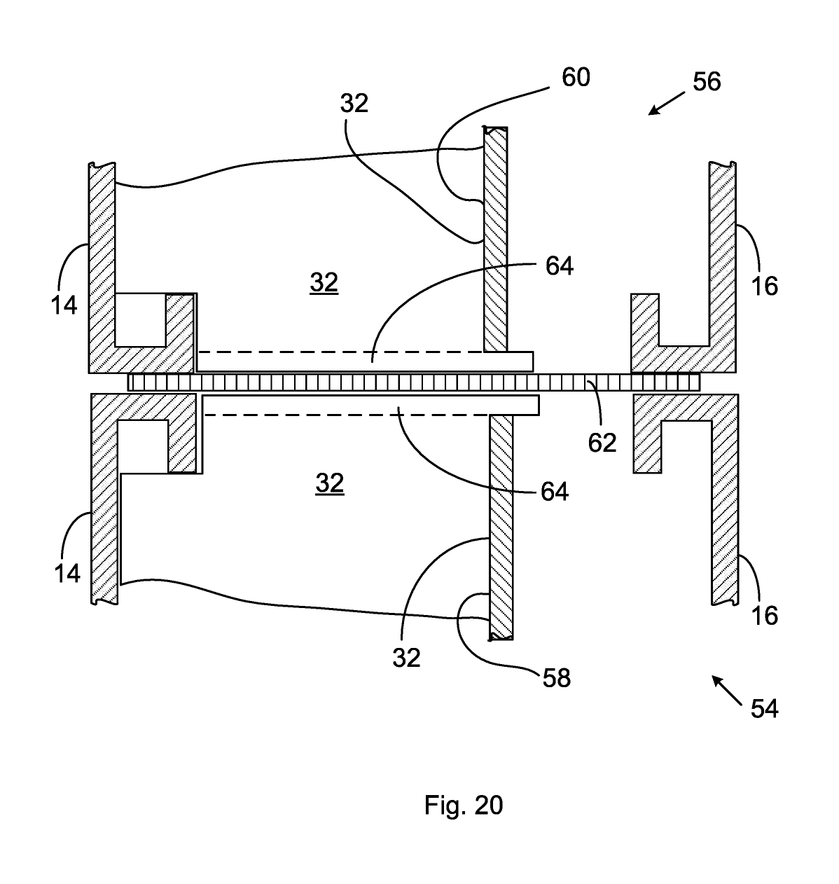

As shown in FIG. 20, the flange 64 of each duct 58, 60 is aligned with the ends of the respective inner and outer skins 14, 16 of its respective panel 54, 56, so that, when the hook and pin assemblies 20, 22 pull the modular panels 54, 56 together, they not only press the abutting ends of the skins 14, 16 together to form a seal between the panels 54, 56, but they also press the abutting flanges 64 together to form a seal between the ends 52A, 50A of the ducts 58, 60. In this embodiment, a gasket 62 has been placed between the abutting flanges 64 and between the abutting ends of the skins 14, 16 to help ensure a good seal, but the gasket 62 may not be needed.

On each panel 54, 56, the aligned flange 64 and end of the inner skin 14 provide a smooth sealing surface for the gasket 62.

FIGS. 19 and 20 show that a small portion of the end of the internal wall 32 adjacent to the inner skin 14 has been cut away to receive the bent-over end of the inner skin 14.

It will be obvious to those skilled in the art that modifications may be made to the embodiments described above without departing from the scope of the invention as claimed.

What is claimed is:

1. An insulated panel arrangement, comprising:
a modular insulated panel having a pair of opposed left and right panel ends and a pair of opposed top and bottom panel ends, said modular insulated panel including parallel, spaced-apart inner and outer planar skins defining an interior space between said inner and outer planar skins, and an insulated core extending between said inner and outer planar skins and generally filling said interior space;
wherein each of said planar skins has a pair of opposed top and bottom edges and a pair of opposed left and right edges, with at least one pair of opposed edges on each of said planar skins being bent toward the other of said planar skins to define two pairs of first and second opposed end faces located at respective first and second opposed panel ends;
a hook assembly at the first of said respective opposed panel ends; and
a pin assembly at the second of said respective opposed panel ends, directly opposite the hook assembly so that, when two of said modular insulated panels are placed end to end, with the first respective opposed panel end of one modular insulated panel abutting the second respective opposed panel end of the other modular insulated panel, the hook assembly on the one modular insulated panel engages the pin assembly on the other modular insulated panel to pull the two modular insulated panels together;
wherein said one modular insulated panel has an internal wall between the inner and outer planar skins defining an internal chamber isolated from said insulated core, said internal chamber having an inlet opening and an outlet opening, so that air can flow into said panel through said inlet opening, through said internal chamber, and out of said panel through said outlet opening.

2. An insulated panel arrangement as recited in claim 1, wherein said inlet opening includes an opening through said outer skin, and said outlet opening includes an opening through said inner skin.

3. An insulated panel arrangement as recited in claim 1, wherein said insulated core is expanded polyurethane foam insulation.

4. An insulated panel arrangement as recited in claim 1, wherein said internal wall is secured to said inner planar skin, and said internal wall and said inner planar skin together define said internal chamber.

5. An insulated panel arrangement as recited in claim 4, wherein said internal wall defines ears parallel to and adjacent to said inner planar skin and secured to said inner planar skin.

6. An insulated panel arrangement as recited in claim 4, wherein said internal wall has an arcuate shaped profile.

7. An insulated panel arrangement as recited in claim 1, wherein said internal chamber houses a plurality of electrical resistance heaters.

8. An insulated panel arrangement as recited in claim 1, wherein said internal chamber houses an evaporator coil for chilling the air passing through said internal chamber.

9. An insulated panel arrangement as recited in claim 1, wherein at least one of said pair of opposed top and bottom panel ends defines at least one of said inlet and outlet openings.

10. An insulated panel arrangement as recited in claim 1, wherein at least one of said inlet and outlet openings extends through one of said panel ends.
